(19) United States
(12) Patent Application Publication
(10) Pub. No.: US 2012/0038571 A1
(43) Pub. Date: Feb. 16, 2012

(54) System and Method for Dynamically Resizing an Active Screen of a Handheld Device

(76) Inventor: Marco Susani, Chicago, IL (US)

(21) Appl. No.: 13/206,680

(22) Filed: Aug. 10, 2011

Related U.S. Application Data
(60) Provisional application No. 61/373,065, filed on Aug. 12, 2010.
(60) Provisional application No. 61/372,538, filed on Aug. 11, 2010.
(60) Provisional application No. 61/372,686, filed on Aug. 11, 2010.

(51) Int. Cl. G06F 3/041

(52) U.S. Cl. 345/173

(57) ABSTRACT

A handheld computing device having a first side with a touch screen configured to determine if contact with a user is an intended interaction with an application running on the touch screen or the user holding the device. The touch screen is configured to create an inactive screen portion and reconfigure an active screen portion upon determining contact is a user holding the device.

### CROSS-REFERENCE TO RELATED APPLICATIONS

The present application claims the benefit of U.S. Provisional Application No. 61/373,065 filed on Aug. 12, 2010, U.S. Provisional Application No. 61/372,538 filed on Aug. 11, 2010, and U.S. Provisional Application No. 61/372,686 filed on Aug. 11, 2010, the contents of which are incorporated herein by reference.

### FEDERALLY SPONSORED RESEARCH OR DEVELOPMENT

N/A

### FIELD OF THE INVENTION

The present invention generally relates to a system and method for dynamically resizing the viewable area of a touch screen in a hand held device to accommodate a user's hand contacting a portion of the screen proximate an edge.

### DESCRIPTION OF THE PRIOR ART

Technology advances and cost reductions allow handheld devices (e.g. touch-screen cell phones or letter-sized tablet computers) to have larger and larger screens. Screen size is perceived as an important value by the users, and devices with a larger screen are more usable and more competitive on the market.

On touch screen-based devices like tablets, however, screen size is forced not only by the obvious limit of not exceeding the actual footprint of the device, but by the need to leave space on the edges to grip and hold the device. The most obvious solution is to leave a large border around the screen, thus preventing accidental action of the touch screen and guaranteeing full visibility of content, no matter how the device is held. Since the device is usually held with only one hand and often held in either portrait or landscape position, however, this solution reduces the active area of the screen on all edges, wasting precious active area, and in case the device is docked, creates a permanent, useless inactive border around the device.

The present invention provides a device and method that enables use of a touch screen in a handheld device without requiring a large border.

### SUMMARY OF THE INVENTION

A first invention disclosed herein provides a device having a touch screen configured to render a portion of the touch screen inactive, and reconfigure the size and position of an active screen portion upon sensing contact along a portion of the touch screen proximate an edge. The invention also provides a method for rendering a portion of a touch screen inactive and reconfiguring a remaining active screen portion.

In accordance with one embodiment of the invention, a computing device, such as a tablet pc, having a generally rectangular touch screen with a small border is provided. The device comprises a first side including a generally rectangular touch screen having a first side edge and an opposing second side edge and a first end edge and an opposing second end edge. The touch screen is configured for user interaction with an application. The touch screen is further configured to sense contact proximate one of the first and second side edges and first and second end edges, and to determine if such contact is intended user interaction with an application or grasping of the device by the user to hold in a useable position. Upon determination of the contact being grasping of the device by the user, the touch screen is further configured to create an inactive screen portion proximate the contact area and an active screen portion for the remainder of the touch screen.

In one orientation of the screen, the inactive screen portion is displayed as a solid band extending from one of the first side edge to the second side edge proximate the first end edge and the first side edge to the second side edge proximate the second end edge. In another orientation, the inactive screen portion is displayed as a solid band extending from one of the first end edge to the second end edge proximate the first side edge and the first end edge to the second end edge proximate the second side edge. Alternatively, the band can be translucent.

The touch screen is configured to enable the active screen portion spring back to a full screen mode when contact is no longer sensed. This removes the inactive portion.

The touch screen can be configured to sense the size of the area of the contact and compare the sensed area size to a predetermined area size to determine if the contact is one of intended user interaction with an application and grasping of the device by the user to hold in a useable position. Also, the touch screen can be configured to sense a duration of the contact and to create the inactive portion when the sensed duration extends beyond a predetermined time period.

In accordance with another embodiment, a method for reconfiguring an active screen portion of a touch screen in a handheld computing device is provided. The method comprises providing a handheld computing device having a first side with a touch screen, sensing contact proximate an edge of a touch screen, and determining if such contact is one of an intended interaction with an application or a user holding the device. The method also includes, upon determining the contact is a user holding the device, creating an inactive screen portion proximate the contact area on the touch screen, and reconfiguring an active screen area for the remaining portion of the touch screen.

The step of determining if such contact is one of an intended interaction with an application or a user holding the device includes determining the area of contact and comparing the area of contact with a predetermined contact area limit. That is, a fingertip or stylus—which are typically used for a variety of interactions with a touch screen device—will likely have less surface contact area than a portion of a hand grasping the side of the screen. Accordingly, the size of the contact may be indicative of whether the device is being held along an edge or being interactively engaged.

Alternatively the step of determining if such contact is one of an intended interaction with an application and a user holding the device includes determining a duration of contact and comparing the duration with a predetermined duration limit. A quick swipe or tap on a screen is more indicative of an interaction or attempted interaction with an application than a prolonged contact that lasts for a longer period of time.

Another method of determining if such contact is one of an intended interaction with an application and a user holding the device includes determining if the contact involves movement and/or the positioning of the contact coincides with an active element on the screen. For example, if the contact is positioned generally on a link, such contact may be an intended attempt to open the link. Moreover, the determining step may include a combination of the actions described.

The step of creating an inactive screen portion proximate the contact area on the touch screen can comprise displaying a dark band along an edge of the touch screen proximate the sensed contact which encompasses the sensed contact. Alternatively, the step of creating an inactive screen portion proximate the contact area on the touch screen can comprise displaying a translucent band along an edge of the touch screen proximate the sensed contact which encompasses the sensed contact.

In accordance with another embodiment of the invention, a tablet computing device comprises a touch screen positioned on a first side of the computing device, the touch screen configured to sense a first hand grasping a portion of the touch screen proximate an edge of the touch screen and create a first inactive screen portion proximate the sensed first grasping hand, and to reconfigure an active portion of the touch screen to a remaining portion of the touch screen. The inactive screen portion can be a band extending along an edge of the touch screen. Alternatively, the inactive screen portion can be translucent. Moreover, the inactive portion can be a close approximation of a contact area of the sensed grasping hand rather than a full band along an edge of the screen.

The inactive portion of the touch screen of the tablet computing device can be configure to include is a first inactive portion proximate the first hand grasping portion and a second inactive portion proximate a second hand grasping portion. This occurs when a user grasps the device in both hands.

A second invention disclosed herein provides a physical interface control used in combination with a device having a touch screen interface. The physical interface control can be a knob, dial, button, switch or other similar physical actuator. The physical control is mounted on the touch screen display of a device for direct contact with the surface of the touch screen. This provides a physical—i.e., tactile—interactive control for use with applications displayed on the touch screen.

With the diffusion of digital information and digital controls (i.e. drive-by-wire in a car), and the cost reduction of touch screen displays, a pervasive diffusion of touch screens should be expected. In some applications, however, the clear advantages of a touch screen (the ability to display dynamic information and high resolution, high quality graphic controls and content) may be overcome by its lack of tactile sensation. For usages that sometimes require ‘blind’ activation (such as the central console of a car or toys for young children), the lack of tactile presence is a major disadvantage.

In addition to activation of an application through a touch screen interface, some devices also include physical controls or interfaces mounted adjacent or near the touch screen (e.g. proximate a side or edge of the touch screen). However, this requires the space to provide a duplicate set of physical controls to go along with the touch screen's interface. When space is limited, the touch screen must be sized to accommodate the physical controls and cannot be as large as it could have been if the physical controls were not present. One example of this situation is a touch screen GPS device mounted in an automobile. In these situations, the physical controls typically do not directly interact with the display.

In one known device, the Bang & Olufsen Beosound 5, a physical dial control is mounted adjacent an edge of a touch screen device and includes a portion that extends onto the surface of the touch screen proximate the edge. However, such configurations limit the control to such positions along an edge of a touch screen. The second disclosed invention provides an improved combination of physical controls for use with touch screen devices.

In accordance with this second invention, the display on the touch screen can be coordinated with the physical control, and provide static or dynamic labels (or other display components) around the control. The visual elements on the display can be changed if the touch screen is used for a different application requiring different control parameters. For example, the display can be configured to utilize a physical dial as a “volume” control in a music application, and a “fan” control in an air conditioning application. Different visual display elements would appear around the dial in each instance.

In accordance with one embodiment of the second invention, a device having physical controls for use with a touch screen is provided. The device comprises a touch screen display interface and, a physical control actuator mounted to a portion of a surface of the touch screen display interface. The physical control actuator interacts with the touch screen to control an application running on the device.

The physical control actuator can be a rotatable knob, button, switch or other similar actuator device. The physical control actuator can be mounted to the surface of the touch screen by an adhesive. Such devices can be used in automobiles and other similar means for transportation.

A third invention disclosed herein provides a device having a flat screen display having a unique lens element. Prior to the third invention, flat screens in devices included a mechanical (i.e., physical) border or frame that contains and supports the screen. Accordingly, such screens only have visible active displays that extend to the border or frame containing the screen. Thus, devices have not been made having an active display that extends to an absolute edge of the device. Instead, the display stops at the border or frame.

The third invention provides a lens element that cooperates with a digital image signal that has been deformed or distorted from an original image, to extend a displayed image past the border or frame supporting the screen. The device uses a combination of digital and reverse optical anomorphic deformation to extend the distorted image beyond the border or frame to restore the original image and appear as a final image. In this regard, the lens is a composite lens having anomorphic optical properties along a first side edge and a second side edge, and normal optical properties in a middle portion between the side edge portions.

In accordance with one aspect of the third invention, a device having a borderless display is provided. The device comprises a flat screen contained along a first side and a second side by a border. The screen is visible only between an inner edge of the border on the first side and an inner edge of the border on the second side. The device further includes a lens covering the flat screen having a first edge portion extending above and over the border to an outer edge of the border on the first side of the screen and a second edge portion extending above and over the border to an outer edge of the border on the second side of the screen. In operation, an image to be displayed on the device is modified from an original image to include a first deformed or distorted portion along a first edge of the image and a second deformed or distorted portion along a second edge of the image. The first edge portion and the second edge portion of the lens are configured to restore the first and second distorted portions to create a final image that covers the border from the outer edge on the first side of the screen to the outer edge on the second side of the screen.

The image produced by the lens can be created by a group of pixels on the visible portion of the screen proximate the inner edge of the border on the first side and a group of pixels on the visible portion of the screen proximate the inner edge of the border on the second side that have been deformed or distorted by an anomorphic engine.

The device can be a cellular phone, tablet computer, computer monitor, flat screen television, or other similar device requiring use of a flat screen display.

Further aspects of the inventions are disclosed in the description of the invention and the Figures.

### BRIEF DESCRIPTION OF THE DRAWINGS

To understand the present inventions, they will now be described by way of example, with reference to the accompanying drawings in which:

FIG. 1 is a front view of a touch screen device in a portrait configuration in accordance with a first disclosed invention;

FIG. 2 is a front view of the touch screen device of FIG. 1 held by a user's left hand on the left side of the device illustrating a dynamically reconfigured active screen area;

FIG. 3 is a front view of the touch screen device of FIG. 1 held by a user's right hand on the right side of the device illustrating a dynamically reconfigured active screen area;

FIG. 4 is a front view of the touch screen device of FIG. 1 in a landscape configuration;

FIG. 5 is a front view of the touch screen device of FIG. 4 held by a user's left hand on the left side of the device illustrating a dynamically reconfigured active screen area;

FIG. 6 is a front view of the touch screen device of FIG. 4 held by a user's right hand on the right side of the device illustrating a dynamically reconfigured active screen area;

FIG. 7 is a front view of the touch screen device of FIG. 4 held by a user's left hand on the left side of the device and right hand on the right side of the device illustrating a dynamically reconfigured active screen area

FIG. 8 is a perspective view of a control interface used with a touch screen in accordance with an aspect of a second disclosed invention;

FIG. 9 is a cross-sectional view of the control interface and touch screen of FIG. 8 taken along the line A-A;

FIG. 10 is an exploded view of a control interface and touch screen in accordance with an aspect of the second disclosed invention;

FIG. 11A is a perspective view of a control consul in an automobile in accordance with the prior art;

FIG. 11B is a perspective view of a control consul in an automobile having a touch screen in accordance with an aspect of the second disclosed invention; and,

FIG. 11C is the control consul of FIG. 11B with a physical actuator connected to a portion of the touch screen.

FIG. 12 is a cross-sectional view of a flat screen having a lens element for providing a borderless display and also illustrating an original image, deformed or distorted image and final image that is being displayed in accordance with a third disclosed invention;

FIG. 13 is the original and final display images with superimposed vertical section lines representing columns of pixels or groups of pixels as shown in FIG. 12; and,

FIG. 14 is the intermediate, distorted, display image with superimposed vertical section lines representing columns of pixels or groups of pixels where the image is deformed proximate the first and second sides of the image as shown in FIG. 12.

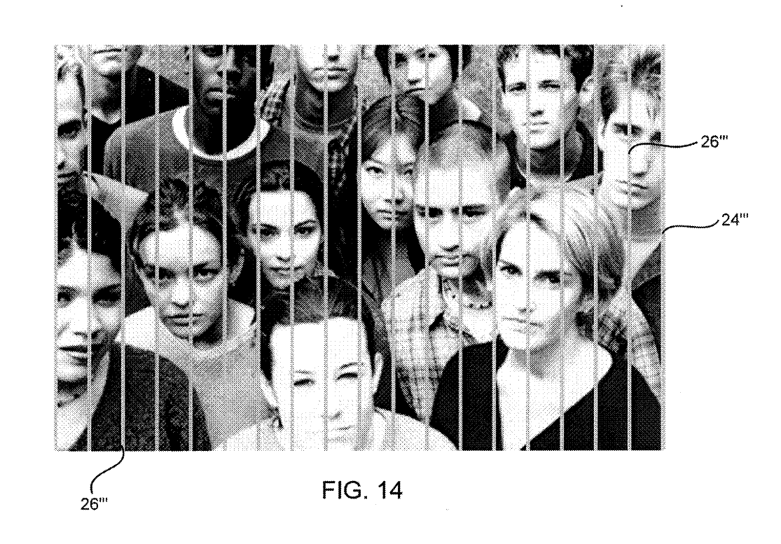

### DETAILED DESCRIPTION

While the inventions disclosed herein are susceptible of embodiments in many different forms, there is shown in the Figures and will herein be described in detail preferred embodiments of the inventions with the understanding that the present disclosure is to be considered as an exemplification of the principles of the inventions and is not intended to limit the broad aspect of the inventions to the embodiments illustrated.

Similar numbering has been used for the several inventions disclosed. However, like numbers of one invention are not intended to mean or refer to the same element of another invention. Non-primed and single primed numbers (e.g., 12 and 12′) are utilized with reference to the first invention; double primed numbers (e.g., 12″) are utilized with reference to the second invention; and triple primed numbers (e.g., 12′″) are utilized with reference to the third invention (thus, 12 and 12′ are not necessarily equivalent or similar elements to 12″ or 12′″).

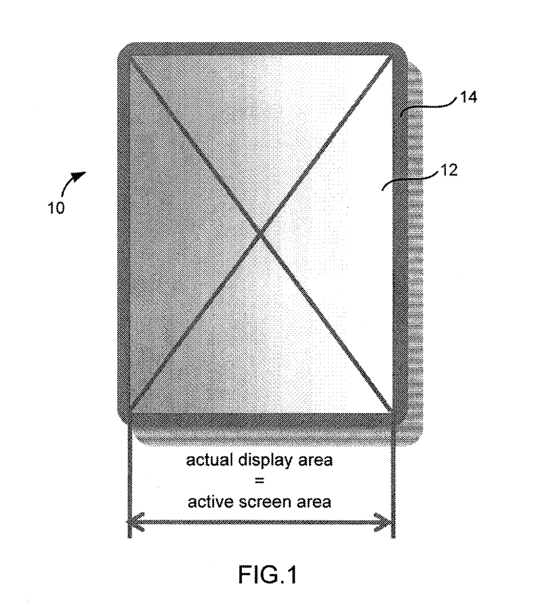

In accordance with the first disclosed invention, FIGS. 1-3 show a handheld computing device 10 having a centrally located, generally rectangular touch screen 12. A thin border 14 surrounds the touch screen 12 around its edges. In these Figures, the device 10 is oriented in a portrait position. Such devices can be, for example, tablet personal computers and other similar devices.

Touch screens are utilized as a user interface, and interact with a user through physical contact with the screen. Such interaction may be with a user's finger or a stylus configured to operate with the touch screen. The screen senses any contact and translates the contact to an application (e.g., program, game etc.) residing on the device 10. This contact can cause the application to react in a number of ways. For example, contact with a link embedded in a web page can cause the application (such as an Internet browser) to move to a new page. Other types of contact can be used to resize photos or interact with various gaming applications. In addition to a number of known responses to contact with the screen, new uses for different types of contact are continuously being created.

In many instances, it is advantageous for a device to have as large of a touch screen as possible. However, in the past, limits to the screen size (or enlargements to the device size) were implemented in order to accommodate a user's grasp of the device. In this regard, large borders were used so that the user's grasp of the device (to hold it in a proper position for use) would not contact the screen and inadvertently activate some aspect of an application on the screen (e.g., contacting an icon and thus launching an application, or interaction with an application already running).

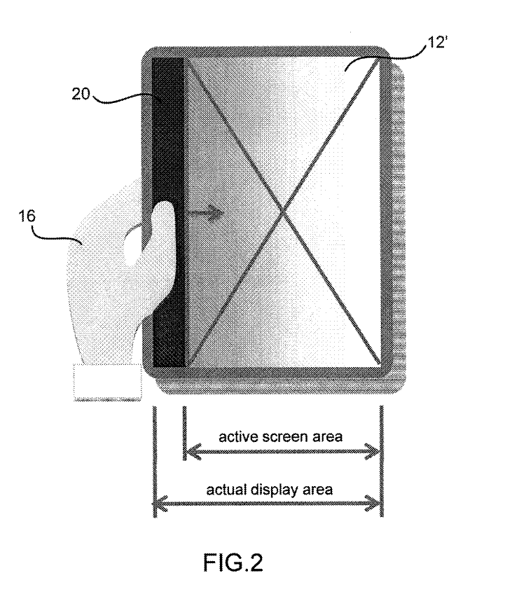

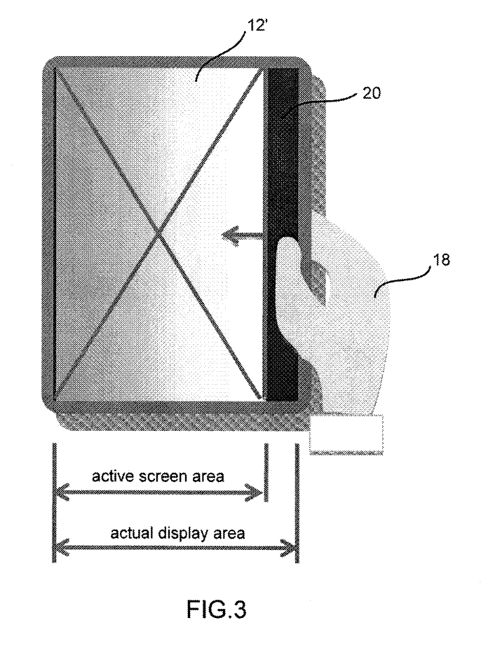

The present invention allows for a larger touch screen (or use of a smaller border) by sensing a user's grasp proximate an edge of the screen, recognizing that such contact is not intended to interact with any application, and then resizing the active portion of the screen to accommodate the hand grasping the device. This is shown in FIGS. 2 and 3 in which a user is holding the device 10 in a left hand 16 (FIG. 2) or right hand 18 (FIG. 3). In each instance, the active portion of the touch screen 12′ is reconfigured (i.e., resized and positioned) to exclude a band or area 20 occupied by the user's hand.

In the embodiment of the invention shown in FIGS. 2 and 3, the excluded area 20 is shown as a dark rectangular band extending from the bottom of the screen to the top. The active screen portion 12′ is completely removed from this region. The rectangular shape of the band allows the reconfigured active screen portion 12′ to maintain a generally rectangular shape.

In other embodiments, it is contemplated that the band 20 only extend from proximate or just below the bottom of the hand contact area to just above the top of the contact area. In this instance the remainder of the band 20 could be filled as part of the active screen portion 12′. Similarly, the inactive portion could be an irregular shape exactly or closely matching the area covered by the grasping hand.

In accordance with another embodiment, the band 20 can simply be a translucent image (e.g., a slightly darkened area, or some other type of indicator) overlaying a full screen 12. In this instance, the application will not allow any contact in this region to be recognized or acted upon by the application. While the image in this inactive portion would be visible, only the remainder of the screen would be active.

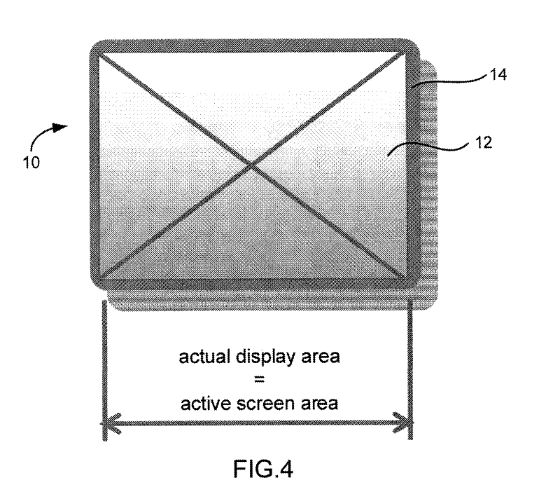

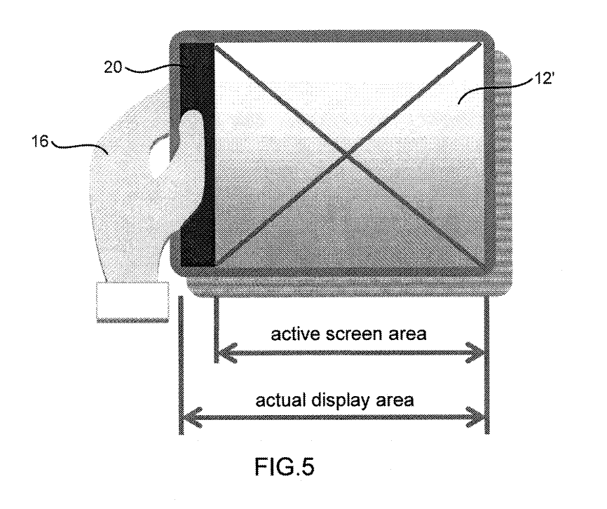

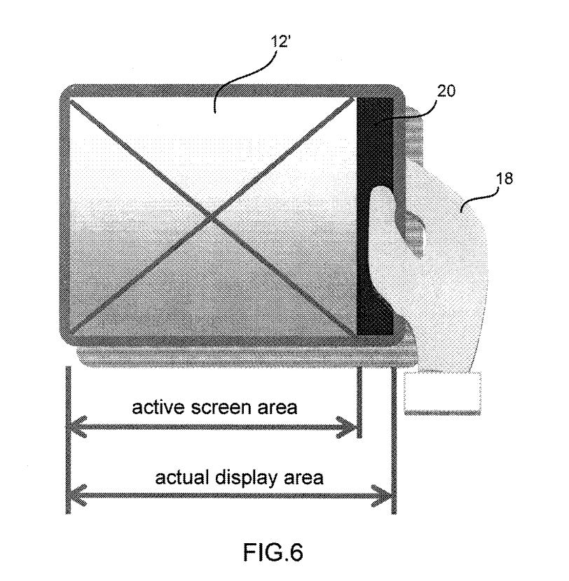

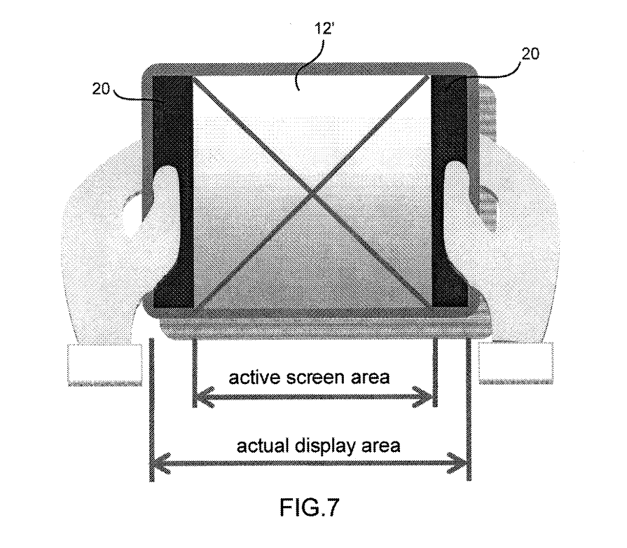

FIGS. 4-7 show the same concepts with the device 10 in a landscape orientation. In the example shown in FIG. 7, both a first and a second inactive band 20 are created when both hands are grasping the device 10 (this would apply equally to the portrait orientation of FIGS. 1-3). Additionally, in either orientation, a hand grasping proximate the top or bottom of the device 10 would create a horizontal band, as opposed to the vertical bands shown.

A number of different algorithms can be utilized to enable the device to recognize such contact and to reconfigure the active portion of the screen in accordance with the embodiments shown and described. In accordance with one algorithm, the device is configured to sense contact proximate the edges of the touch screen, and to determine if the contact is one or more of: larger than a typical or predetermined contact area used for interaction with an application (e.g., a palm as opposed to a finger tip), or the contact is longer in duration than a typical or predetermined contact time used for interaction with an application. In another possible algorithm, the device senses whether the contact is moving in accordance with a known interactive movement (e.g., pinching or expanding a photo). The device can then create an inactive band sized to accommodate the contact, and resize the active screen accordingly. In this or another embodiment, the device can be provided with an accelerometer to determine if the user is holding the device (in this regard, users of the device typically tend to place their hands along the horizon, so a contact in the upper and lower edges should not be interpreted as the user's grip).

Another algorithm that may be employed is:

Conditions
if front multi-touch screen is available

Definition of detection areas (center area of one side, edge, horizontal hold compared to horizon mean hold)

Surface of front touch (larger surface means holding)

Constant presence of above touch in time (longer presence means hold)

Left and right combined touch (co-presence of symmetric left and right means hold)
if rear or edge touch detection is available

Combination of front and rear touch in same area (combined touch means holding)
Actions

If <all conditions are met> then <deactivate area touched and resize display>

Another method that can be employed is to have a user actively select a setting (e.g., via either a button on the device, or a button or gesture through the touch screen) that automatically configures the device to create one or more inactive bands on one or more select edges, and reconfigures the active display area accordingly.

The device is preferably configured to have the touch screen “spring back” or resize to a full screen mode when the user's hand holding the device and touching the screen is removed. Similarly, docking the device will also cause the touch screen to resize to a full screen.

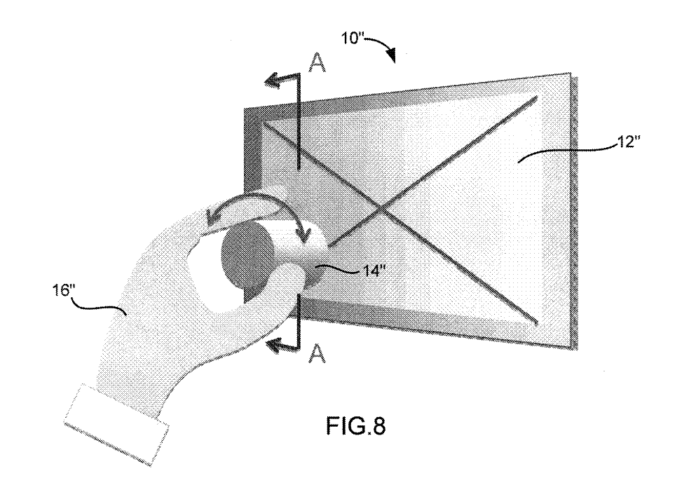

In accordance with a second invention shown in FIGS. 8-10, a device 10″ having a touch screen display 12″ with a physical control 14″ is provided. The physical control 14″ is in the form of a rotating knob or dial that is mounted directly to the surface of the touch screen display 12″. The knob 14″ can be rotated by a user 16″ to affect interaction with an application running on the device 10″ through the touch screen 12″.

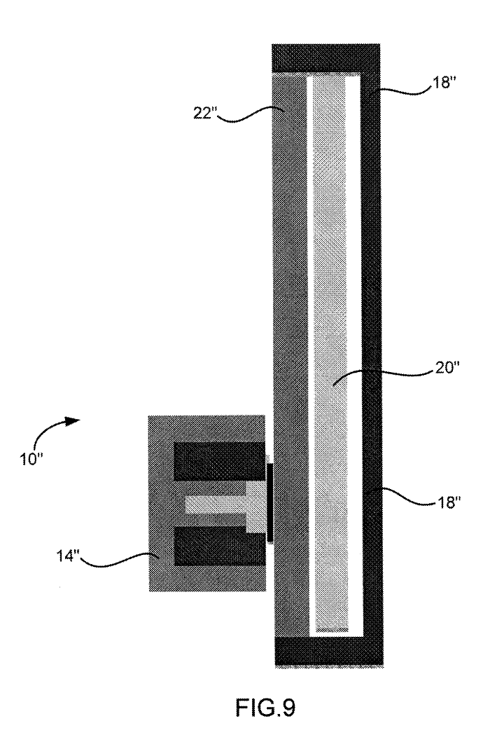

Referring to FIG. 9, the touch screen display includes a display component 20″ and a touch sensitive component 22″. Both components are housed in a case 18″. The knob 14″ is adhered to the touch sensitive component 22″ of the touch screen 12″. In this example, the touch screen 12″ is a capacitive type screen, however, resistive or other types of screens can be utilized.

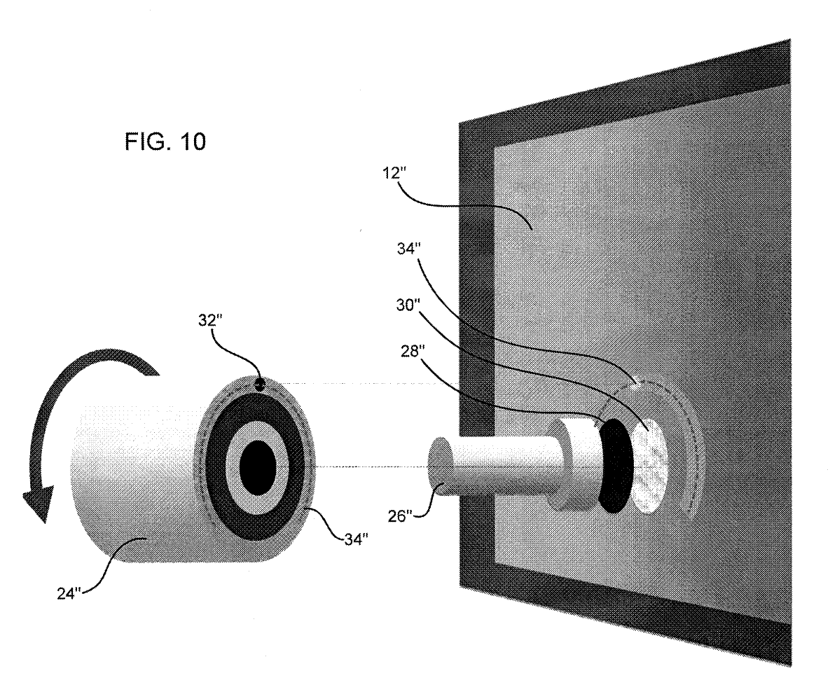

The knob 14″ is shown in more detail in the exploded view of FIG. 10. The knob 14″ includes a handle portion 24″ that fits about an axle 26″. The axle 26″ is adhered to the touch screen 12″ by a bond 28″. The display can be configured to picture the appropriate bonding area 30″ for the knob 14″.

The handle 24″ of the knob 14″ includes a capacitive actuator 32″ mounted on a surface facing the touch screen 12″. The actuator 32″ interfaces with the touch screen to interact with an underlying application (i.e., controller software program) being run on the device. As shown by the dotted line 34″ on the surface of the knob, the actuator 32″ will travel a circular path as the knob handle 24″ is rotated about the axle 26″, matching the capacitive track illustrated by the dotted line 34″ on the screen 12″.

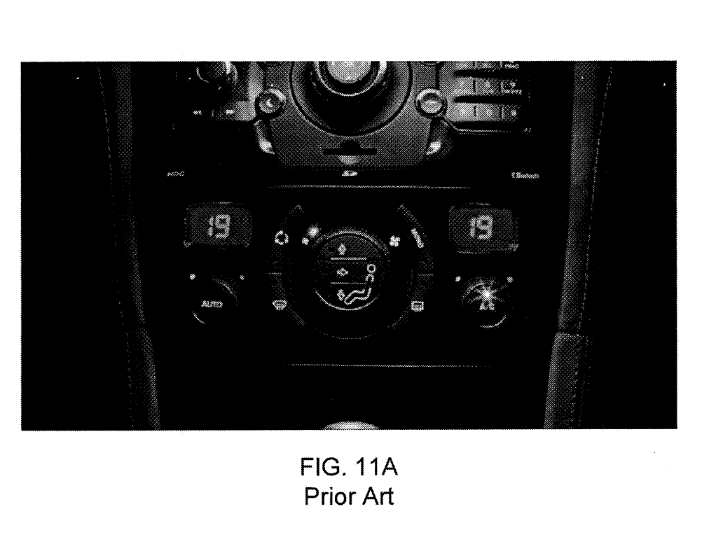

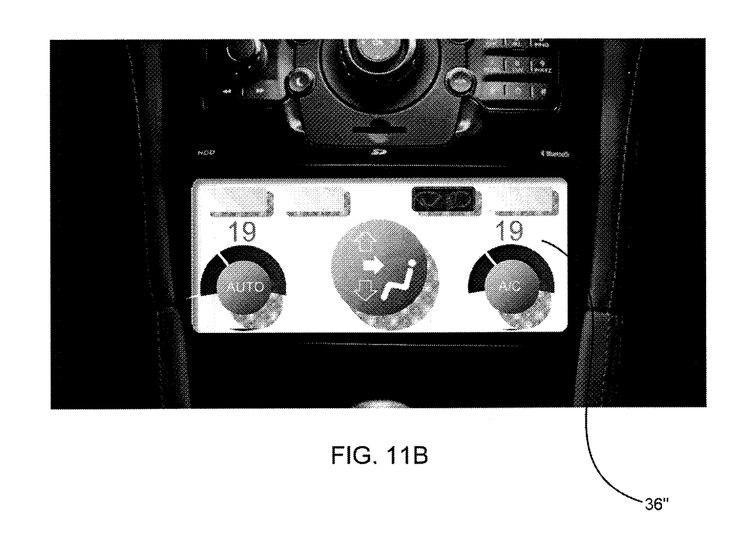

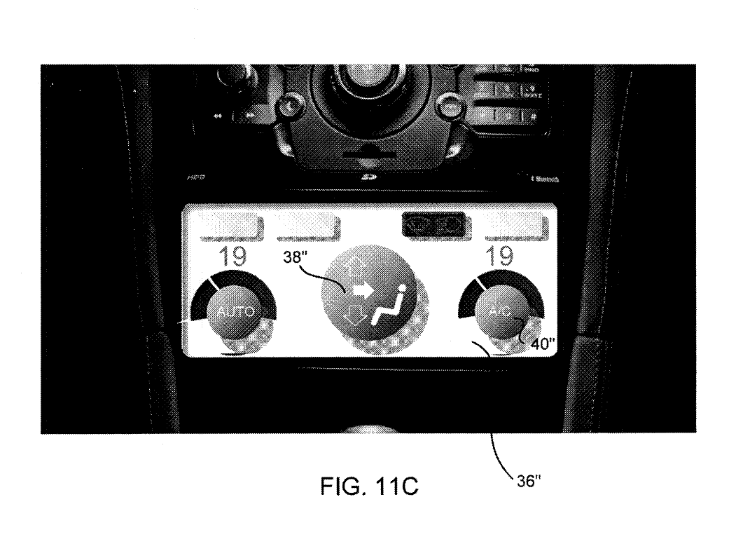

In accordance with one embodiment of the invention, the present device can be utilized to replace controls in an automobile. FIG. 11A shows standard (physical) air conditioning control consul for use in an automobile. These purely physical controls can be replaced by a touch screen 36″ as shown in FIG. 11B. The touch screen 36″ can display one or more static or dynamic labels 38″, and allows for tactile interaction with any control applications running on the system. Referring to FIG. 11C, a physical knob 40″ is placed over the display 36″ for actuating the air conditioning control. The physical knob 40″ allows a driver to change the air conditioning settings by touch without looking down at the display.

This second invention allows for the combination of physical controls with touch screen displays without requiring any special modification to the display. That is, standard rectangular touch screens can be utilized.

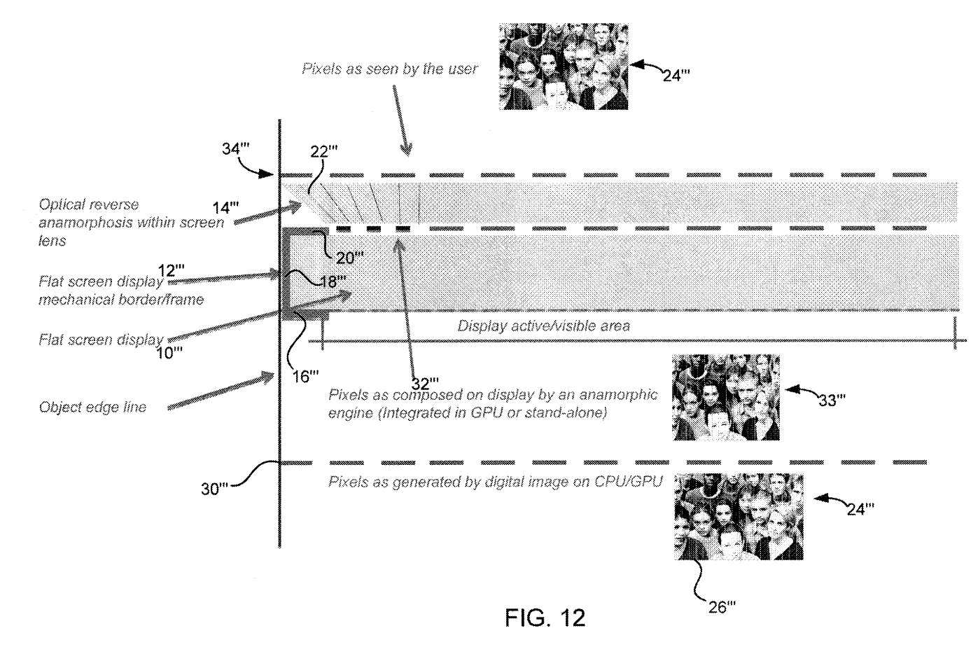

In accordance with a third disclosed invention, FIG. 12 is a cross-sectional view illustrating a device having a flat screen 10′″ that utilizes a composite lens 14′″ to provide an image that extends to an outer edge of a border or frame containing the screen 10′″. This can be used to create a device that includes a display without a visible border.

The flat screen 10′″ is held in place by a mechanical border or frame 12′″ along a first edge (the drawing only shows the left side or edge of the screen, however, the border/frame also contains the right side of the display in a similar manner). The border 12′″ includes a first segment 16′″ that extends along a lower surface of the display screen 12′″, a second segment 18′″ that extends vertically along the edge of the display 12′″ and defines an outer edge of the border, and a third segment 20′″ that extends along the top surface of the display 12′″.

While the first and third segments 16′″, 20′″ of the border 14′″ are shown as being equal, one or the other could extend into the active display surface farther than the other. In either event this extension defines an inner edge of the border and limits the field of view of the flat screen 12′″ and prevents the visible portion of the display from extending completely to an edge of a device. To overcome these limits, the present invention includes the lens element 14′″ on top of the display screen 12′″ to extend the image. The lens element 14′″ includes an edge portion 22′″ along a first edge and an opposing second edge (not shown) that extends above and over the third segment 20′″ of the edge of the border 12′″ (i.e., to cover vertical segment 18′″). The edge portions 22′″ of the lens element 14′″ include optical reverse anamorphosis properties to extend an image provided by the visible portion of the screen 12′″ to the edge of the lens 14′″.

As well known, flat screen displays include rows and columns of pixels which are used to generate images. In the present instance, an original image 24′″ is converted into a digital image (by the central processing unit (CPU) or graphics processing unit (GPU) of a device) that is used to control the pixels of the display.

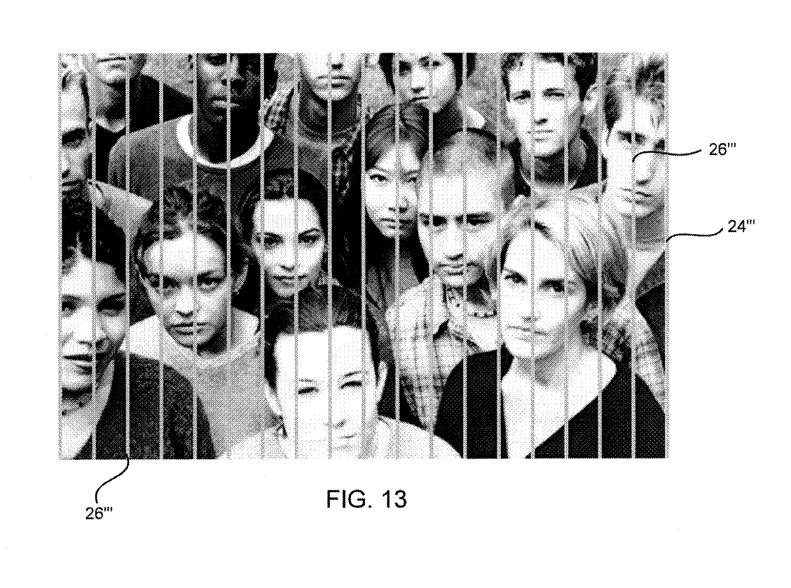

As more clearly shown in FIG. 13, the original image is divided into a plurality of columns (shown separated by yellow lines 26″) of substantially equal width. Each column spans or includes a group of one or more pixels (in this regard, the yellow lines are shown for illustrative purposes only and may be closer together in practice). Referring to a single row of pixels 30′″ (as shown in FIG. 12), the original image signal creates pixels (or pixel groups) of equal width that span the screen (including the portions covered by the border segments 16′″, 18′″).

This original image is then deformed or distorted along the edges 35′″ of the image (e.g., by an anomorphic engine or application) to move the edge of the image inward. This creates a compressed image 33′″ that include a series of distorted pixels or pixel groups 32′″ that extend along each side or edge of the visible portion of the screen (i.e., from the end of the border segment 20′″).

The edge 22′″ of the lens element 14′″ is configured to un-deform or distort the pixels or pixel groups 32′″ (i.e., restore) to recreate a final row of pixels 34′″ showing the final un-deformed or distorted image 24′″ that spans over the border or frame 14′″ to the extreme edge of the border or frame.

Many modifications and variations of the present invention are possible in light of the above teachings. It is, therefore, to be understood within the scope of the appended claims the invention may be protected otherwise than as specifically described.

I claim:

1. A handheld computing device comprising:
a first side including a generally rectangular touch screen having a first side edge and an opposing second side edge and a first end edge and an opposing second end edge, the touch screen configured for user interaction with an application wherein the touch screen is further configured to sense contact proximate one of the first and second side edges and first and second end edges, and determine if such contact is one of intended user interaction with an application and grasping of the device by the user to hold in a useable position.

2. The hand held computing device of claim 1 wherein the touch screen, upon determination of a contact being grasping of the device by the user, is further configured to create an inactive screen portion proximate the contact and an active screen portion for the remainder of the touch screen.

3. The hand held computing device of claim 2 wherein the inactive screen portion is displayed as a solid band extending from one of the first side edge to the second side edge proximate the first end edge and the first side edge to the second side edge proximate the second end edge.

4. The hand held computing device of claim 2 wherein the inactive screen portion is displayed as a solid band extending from one of the first end edge to the second end edge proximate the first side edge and the first end edge to the second end edge proximate the second side edge.

5. The hand held computing device of claim 2 wherein the touch screen is configured to enable the active screen portion spring back to a full screen mode when contact is no longer sensed.

6. The hand held computing device of claim 2 wherein the touch screen is configured to sense the size of the area of the contact and compare the sensed area size to a predetermined area size to determine if the contact is one of intended user interaction with an application and grasping of the device by the user to hold in a useable position.

7. The hand held computing device of claim 2 wherein the touch screen is configured to sense a duration of the contact and to create the inactive portion when the sensed duration extends beyond a predetermined time period.

8. The hand held computing device of claim 2 wherein the inactive portion is displayed as a translucent band.

9. The hand held computing device of claim 1 wherein the device is a tablet computer.

10. A method for reconfiguring an active screen portion of a touch screen in a handheld computing device comprising:
providing a handheld computing device having a first side with a touch screen;
sensing contact proximate an edge of a touch screen;
determining if such contact is one of an intended interaction with an application and a user holding the device.

11. The method of claim 10 further comprising:
upon determining the contact is a user holding the device, creating an inactive screen portion proximate the contact area on the touch screen; and,
reconfiguring an active screen area for a remaining portion of the touch screen.

12. The method of claim 10 wherein the determining if such contact is one of an intended interaction with an application and a user holding the device step comprises:
determining the area of contact and comparing the area of contact with a predetermined contact area limit.

13. The method of claim 10 wherein the determining if such contact is one of an intended interaction with an application and a user holding the device step comprises:
determining a duration of contact and comparing the duration with a predetermined duration limit.

14. The method of claim 11 wherein the step of creating an inactive screen portion proximate the contact area on the touch screen comprises displaying a dark band along an edge of the touch screen proximate the sensed contact which encompasses the sensed contact.

15. The method of claim 11 wherein the step of creating an inactive screen portion proximate the contact area on the touch screen comprises displaying a translucent band along an edge of the touch screen proximate the sensed contact which encompasses the sensed contact.

16. A tablet computing device comprising:
a touch screen positioned on a first side of the computing device, the touch screen configured to sense a first hand grasping a portion of the touch screen proximate an edge of the touch screen and create a first inactive screen portion proximate the sensed first grasping hand, and to reconfigure an active portion of the touch screen to a remaining portion of the touch screen.

17. The tablet computing device of claim 16 wherein the inactive screen portion is a band extending along an edge of the touch screen.

18. The tablet computing device of claim 16 wherein the inactive screen portion is translucent.

19. The tablet computing device of claim 16 wherein the inactive portion is a close approximation of a contact area of the sensed grasping hand.

20. The tablet computing device of claim 16 wherein the inactive portion of the touch screen is a first inactive portion proximate the first hand grasping portion and a second inactive portion proximate a second hand grasping portion.
